(19) United States
(12) Patent Application Publication
(10) Pub. No.: US 2013/0041689 A1
(43) Pub. Date: Feb. 14, 2013

(54) MEDICAL RECORD INFORMATION DISPLAY CONTROL METHOD AND APPARATUS

(71) Applicants: Nobuyuki Hirakawa, Kawasaki (JP); Masae Isobe, Kawasaki (JP); Yukio Saito, Kawasaki (JP)

(72) Inventors: Nobuyuki Hirakawa, Kawasaki (JP); Masae Isobe, Kawasaki (JP); Yukio Saito, Kawasaki (JP)

(73) Assignee: FUJITSU LIMITED, Kawasaki-shi (JP)

(21) Appl. No.: 13/563,867

(22) Filed: Aug. 1, 2012

(30) Foreign Application Priority Data
Aug. 9, 2011 (JP) 2011-174320

(51) Int. Cl. G06Q 50/24

(52) U.S. Cl. 705/3

(57) ABSTRACT

A display control method receives, from a server, data input to at least one of display setting items that are preset amongst items included in medical record information, displays on a display unit an all-item display screen that displays the display setting items and the received data, and sets input data on the all-item display screen when the input data with respect to another item other than the at least one of the display setting items is accepted. The all-item display screen may be switched to an input item display screen in response to a switch instruction, wherein the input item display screen displays the at least one of the display setting items, the received data, and the other item.

### CROSS-REFERENCE TO RELATED APPLICATIONS

This application is based upon and claims the benefit of priority of the prior Japanese Patent Application No. 2011-174320, filed on Aug. 9, 2011, the entire contents of which are incorporated herein by reference.

### FIELD

The embodiments discussed herein are related to medical record information display control method and apparatus to control display of medical record information. The embodiments discussed herein are also related to a non-transitory computer-readable storage medium having stored therein a program for causing a computer to execute a process of controlling display of medical record information.

### BACKGROUND

Conventionally, physicians recorded patient's medical history on paper medical records. However, electronic medical record systems and the like have been proposed in which the medical records in electronic form are centrally recorded and managed in a database. Functions of the electronic medical record system may include a viewer function to view medical history information of a patient, such as a medical interview sheet (or medical questionnaire sheet).

The medical record information may include a plurality of attributes, such as basic information, body information, allergy information, and the like. In addition, the medical record information include a plurality of items within each attribute. For example, when the attribute is the basic information, data such as the patient's name, the date of birth, and the family structure are input to items of the basic information.

In the medical record information, a plurality of attributes exist and data are input to a plurality of items of each of the attributes. For this reason, even when the viewer function is used, it may be impossible to view the entire medical record information, and an improved viewing of the medical record information may be desired.

The applicants are aware of a Japanese Laid-Open Patent Publication No. 2007-268021, and “http://www.apius.com/sample_ecru5.htm”.

### SUMMARY

Accordingly, it is an object in one aspect of the embodiment to provide a medical record information display control method and apparatus, and a computer-readable storage medium, which may improve viewing of the medical record information.

According to one aspect of the present invention, a medical record information display control method may include receiving from a server by a computer, data input to at least one of a plurality of display setting items that are preset amongst a plurality of items included in medical record information; displaying on a display unit by the computer, an all-item display screen that displays the plurality of display setting items and the received data; setting by the computer, input data on the all-item display screen when the input data with respect to another item other than the at least one of the plurality of display setting items is accepted; switching by the computer, the all-item display screen to an input item display screen in response to a switch instruction; and storing in the server by the computer, data including the input data in response to a store instruction, wherein the input item display screen displays the at least one of the plurality of display setting items, the received data, and the other item.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system structure of an electronic medical record system in a first embodiment;

FIG. 2 is a block diagram illustrating an example of a hardware structure of a client in an embodiment;

FIG. 3 is a diagram for explaining an example of a functional structure of a medical record information management server and the client of the electronic medical record system;

FIG. 4 is a diagram illustrating an example of a medical record information database;

FIG. 5 is a diagram illustrating an example of display setting information;

FIG. 6 is a diagram for explaining an example of a style sheet;

FIG. 7 is a flow chart for explaining an example of a search process of the medical record information management server;

FIG. 8 is a flow chart for explaining an example of a process of the client;

FIG. 9 is a diagram illustrating an example of an all-item display screen;

FIG. 10 is a diagram illustrating an example of a case in which a data input is accepted on the all-item display screen;

FIG. 11 is a diagram illustrating an example of an input item display screen already input with the data;

FIG. 12 is a flow chart for explaining an example of a display switching by a display control module;

FIG. 13 is a diagram illustrating a first example of the display switching between the all- item display screen and the input item display screen;

FIG. 14 is a diagram illustrating a second example of the display switching between the all- item display screen and the input item display screen; and

FIG. 15 is a diagram illustrating an example of the system structure of the electronic medical record system in a second embodiment.

### DESCRIPTION OF EMBODIMENTS

Preferred embodiments of the present invention will be described with reference to the accompanying drawings.

A description will now be given of the medical record information display control method and apparatus, and computer-readable storage medium, in each embodiment according to the present invention.

### First Embodiment

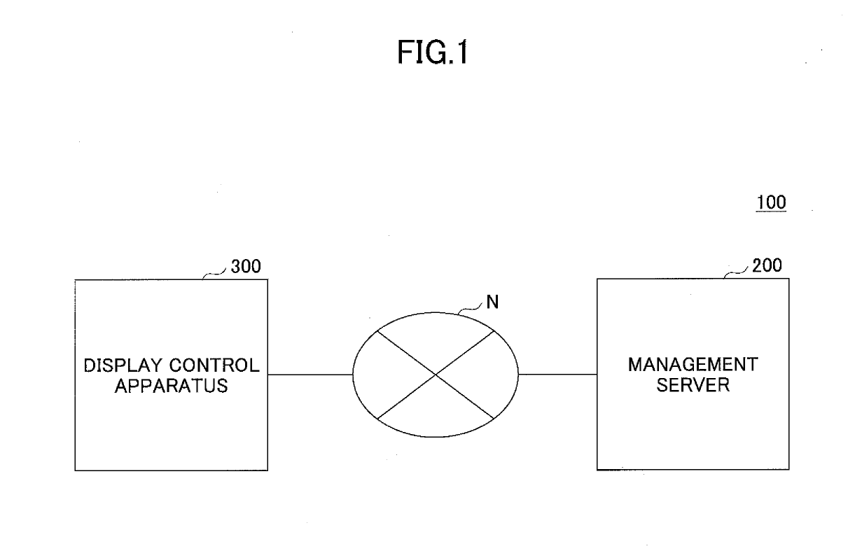

A description will be given of a first embodiment of the present invention. FIG. 1 is a diagram illustrating an example of a system structure of an electronic medical record system in the first embodiment.

An electronic medical record system 100 may include a medical record information management server (hereinafter referred to as “management server) 200, and a medical record information display control apparatus (hereinafter referred to as “display control apparatus”) 300. The management server 200 may be connected to the display control apparatus 300 via a network N. The display control apparatus 300 is an example of a client. The network N may include a cable network, a wireless network, or a combination of cable and wireless networks.

In the electronic medical record system 100, the management server 200 may cause the display control apparatus 300 to display medical record information managed by the management server 200. In addition, the management server 200 may update the medical record information when the medical record information is updated in the display control apparatus 300.

For example, the management server 200 may be set up in a medical institution, such as a hospital. For example, the display control apparatus 300 may be formed by a terminal that is used by medical personnel, such as physicians and nurses.

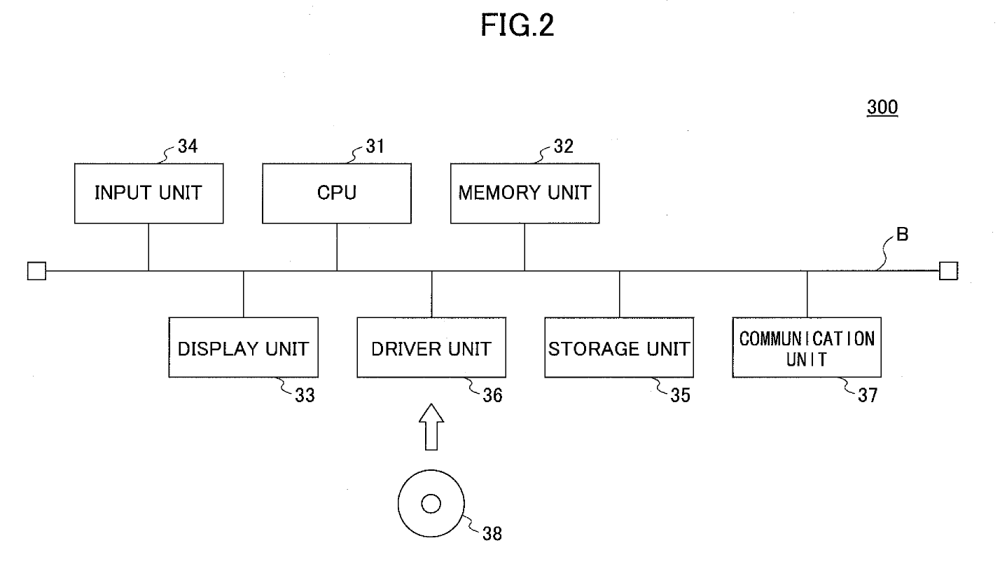

FIG. 2 is a block diagram illustrating an example of a hardware structure of the client in an embodiment. The display control apparatus 300 may be controlled by a computer. The display control apparatus 300 illustrated in FIG. 2 may include a CPU (Central Processing Unit) 31, a memory unit 32, a display unit 33, an input unit 34, a storage unit 35, a driver unit 36, and a communication unit 37 that are connected via a system bus B.

The CPU 31 may control the operation of the display control apparatus 300 by executing one or more programs stored in a memory unit 32. The memory unit 32 may include a RAM (Random Access Memory), a ROM (Read Only Memory), and the like, and may store the programs to be executed by the CPU 31, and various data. The various data may include data preferably used by processes of the CPU 31, and data, including intermediate data, obtained by the processes performed by the CPU 31. A memory region of the memory unit 32 may be allocated for a work area to be used by the processes performed by the CPU 31.

The display unit 33 may display various information under control of the CPU 31. The input unit 34 may include a keyboard, a mouse, and the like, and may be manipulated by a user to input various information to be used by processes performed by the display control apparatus 300.

The storage unit 35 may be formed by a HDD (Hard Disk Drive), for example, and may store data and programs to be executed the CPU 31 in order to perform various processes.

The program for causing the CPU 31 to perform a process (or medical record information display control process) to control the display of the medical record information of the display control apparatus 300 may be stored in a storage medium 38 and provided to the display control apparatus 300. For example, the storage medium 38 may be formed by a computer-readable storage medium, such as a CD-ROM (Compact Disk-Read Only Memory). When the storage medium 38 having stored therein the program is load into the driver unit 36, the driver unit 36 may read the program from the storage medium 38 and install the read program into the storage unit 35 via the system bus B. When the program is started, the CPU 31 may start the process by executing the program installed in the storage unit 35.

The storage medium 38 is not limited to the CD-ROM, and may be formed by any suitable non-transitory computer-readable storage medium. When the display control apparatus 300 performs a network communication with an external apparatus (not illustrated), the program for realizing the process of the display control apparatus 300 may be downloaded via the network N and the communication unit 37 and installed into the storage unit 35. The display control apparatus 300 may further include an interface, such as a USB (Universal Serial Bus), to connect the display control apparatus 300 to an external storage unit (not illustrated). In this case, the program may be read from the external storage unit via the USB connection and installed into the storage unit 35.

A hardware structure of the management server 200 may be similar to the hardware structure of the display control apparatus 300, and thus, a description and illustration thereof will be omitted.

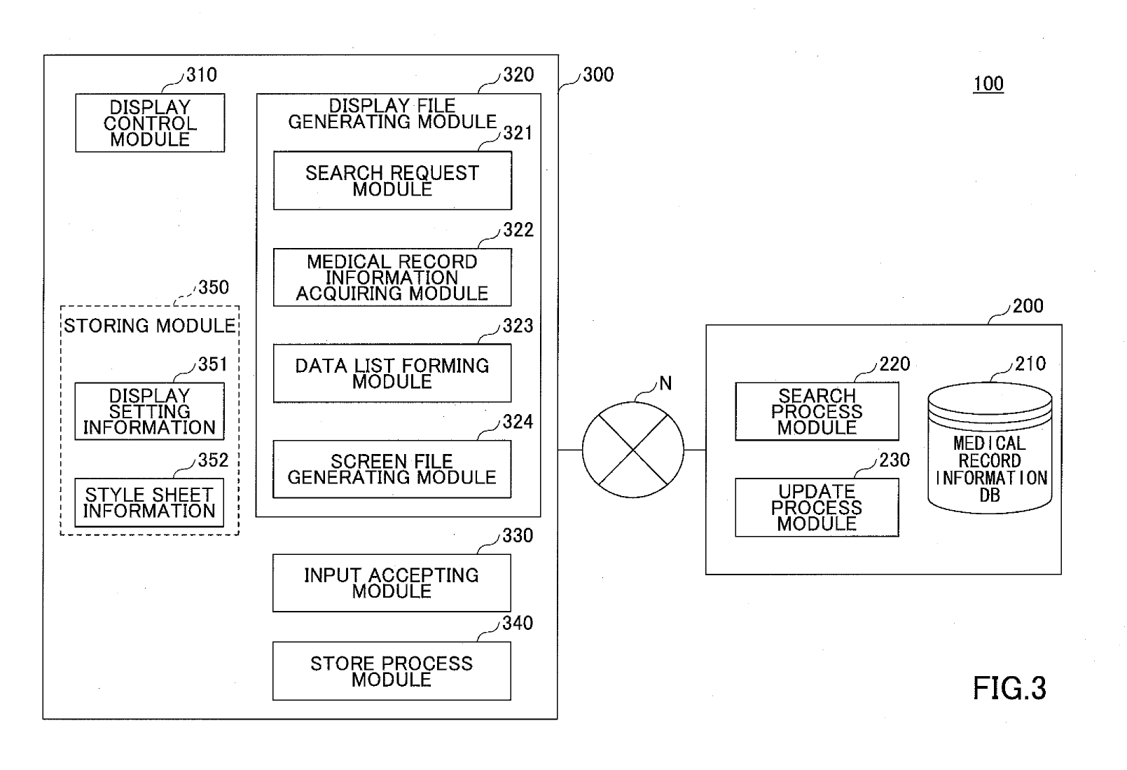

Next, a description will be given of a functional structure of the management server 200 and the display control apparatus 300 of the electronic medical record system 100, by referring to FIG. 3. FIG. 3 is a diagram for explaining an example of the functional structure of the management server and the display control apparatus (or client) of the electronic medical record system.

The management server 200 illustrated in FIG. 3 may include a medical record information database 210, a search process module 220, and an update process module 230.

The medical record information database 210 may be provided in a storage unit (not illustrated) of the management server 200, and store medical record information input from the display control apparatus 300. For example, the medical record information may include profile information, examination records, and the like of the patient. The profile information may include the name, the date of birth, the family structure, body information, allergy information, and the like of the patient. The examination information may include information related to prescription drugs, treatment contents, examination results, and the like.

The search process module 220 may perform a search within the medical record information database 210, in response to receiving a search request from the display control apparatus 300. Details of the search of the search process module 220 will be given later in the specification. The update process module 230 may update the medical record information in the medical record information database 210, in response to receiving a store instruction to store the medical record information from the display control apparatus 300.

The display control apparatus 300 illustrated in FIG. 3 may include a display control module 310, a display file generating (or creating) module 320, an input accepting module 330, a store process module 340, and a storing module 350.

The display control module 310 may control the display to the display unit 33. More particularly, the display control module 310 may realize a viewer function that performs a rendering of a HTML (HyperText Markup Language) file generated by the display file generating module 320. The display file generating module 320 may cause the display control module 310 to display the medical record information stored in the medical record information database 210 of the management server 200.

The input accepting module 330 may accept a new data input when the new data input is made with respect to the medical record information display by the display control module 310. The store process module 340 may receive a store instruction to store the medical record information displayed by the display control module 310, and send the medical record information to the management server 200. The management server 200 may update the medical record information database 210 by the update process module 230 upon receipt of the medical record information. The storing module 350 may be provided in the memory unit 32 and/or the storage unit 35, and store display setting information 351 and style sheet information 352. The display setting information 351 and the style sheet information 352 may be used to generate the HTML file.

The display file generating module 320 may include a search request module 321, a medical record information acquiring module 322, a data list forming module 323, and a screen file generating module 324.

The search request module 321 may issue a search request for the medical record information to the management server 200, in response to an instruction input by the user of the display control apparatus 300. The medical record information acquiring module 322 may acquire the medical record information of a search result in the management server 200.

The data list forming module 323 may form items of data included in the medical record information acquired by the medical record information acquiring module 322 into a list. The screen file generating module 324 may refer to the storing module 350, and generate a HTML file of a screen that displays the medical record information, using the display setting information 351 and the style sheet information 352 stored in the storing module 350, and the list of the data included in the medical record information that is acquired.

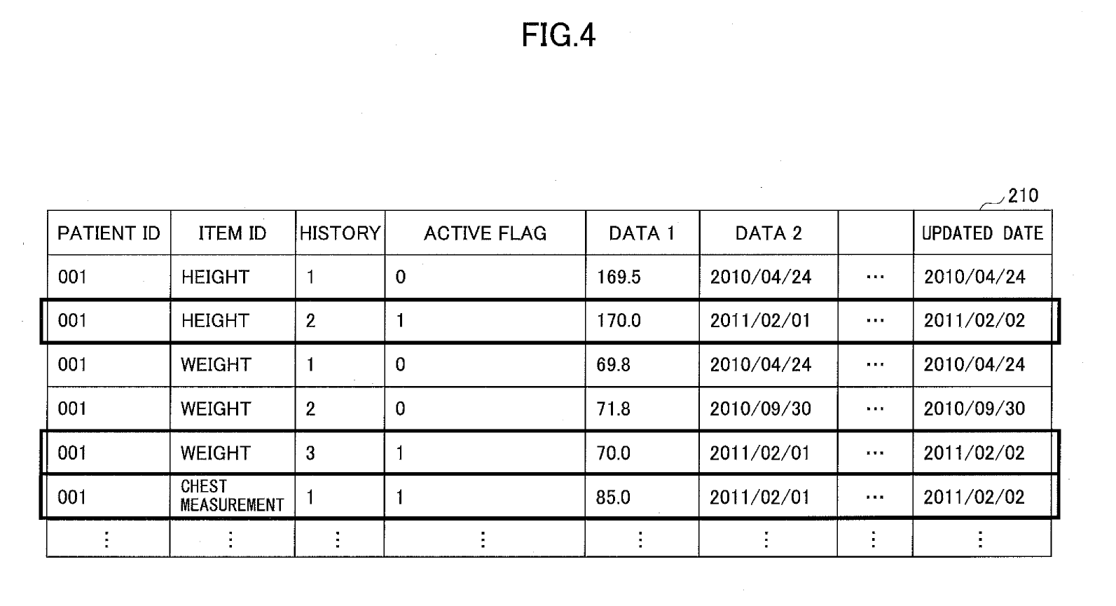

Next, a description will be given of the medical record information database 210, the display setting information 351, and the style sheet information 352, by referring to FIGS. 4 through 6.

FIG. 4 is a diagram illustrating an example of the medical record information database. The medical record information database 210 stores the medical record information for each patient. The medical record information database 210 illustrated in FIG. 4 may store a patient ID, an item ID, a history, an active flag, data 1, data 2, updated date, and the like for each patient.

In the medical record information, the patient ID may be an identifier that identifies each patient. The item ID may be an item indicating what the values of the data 1 and 2 indicate. The history may be provided for each item ID, and indicate the history of the data acquisition. In this example, the history indicates the number of times the data is acquired. Hence, the larger the value of the history, the newer the data.

The active flag may indicate whether the data is the newest data. In this example, the data having the active flag that is “1” (or valid) indicates the newest data. The data 1 and 2 may indicate data corresponding to the item ID. In this example, the data 1 indicates the value of the item ID, and the data 2 indicates the date of acquisition of the data 1. The updated date may indicate a date when the medical record information is sent to the management server 200 and the medical record information database 210 is updated.

In FIG. 4, one of the item IDs corresponding to a patient ID “001” includes “height”. With respect to the height for which the history is “1”, the data 1 is “169.5”, the data 2 is “2010/4/24”, and the active flag is “0”. In other words, the height of the patient ID “001” measured on “2010/4/24” is “169.5” cm, however, it may be seen that this data is not the newest data.

With respect to the height for which the history is “2”, the data 1 is “170.0”, the data 2 is “2011/2/1”, and the active flag is “1”. Further, the updated date is “2011/2/2”. In other words, the height of the patient ID “001” measured on “2011/2/1” is “170.0” cm, which is the newest value. It may be seen that this newest value is sent to the management server 200 and stored in the medical record information database 210 on “2011/2/2”.

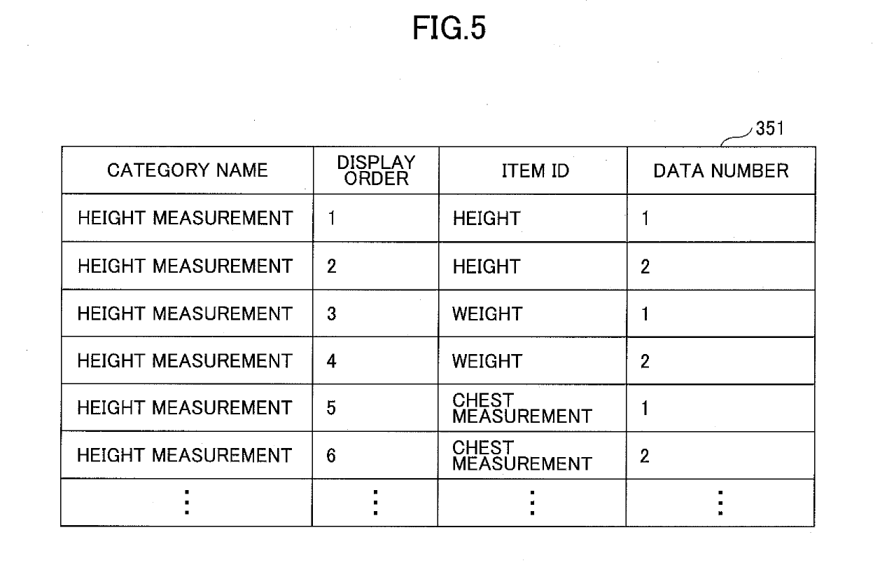

Next, a description will be given of the display setting information 351 stored in the storing module 350 of the display control apparatus 300, by referring to FIG. 5. FIG. 5 is a diagram illustrating an example of the display setting information.

The display setting information 351 may include a category name, a display order, an item ID, and a data number. In this example, the display setting information 351 the category name and the display order, for each of the item IDs included in the medical record information and the corresponding data numbers. In addition, in the display setting information 351, at least profile information forming a part of the medical record information may be set as a display setting item to be displayed.

In the display setting information 351, the category name may indicate the category in which the medical record information is included. For example, the category of the item ID “height” included in the medical record information is “physical examination”. The display order may indicate an order in which the data of the medical record information is to be displayed. More particularly, the display order may indicate the order in which the data corresponding to the item ID is to be displayed with a layout determined by the style sheet information 352. The data number may indicate a number allocated to the data corresponding to the item ID. For example, in the medical record information database 210 illustrated in FIG. 4, the data number of the data 1 is “1”, and the data number of the data 2 is “2”.

In the example illustrated in FIG. 5, item IDs “height”, “weight”, and “chest (or bust) measurement” are included in the category name “physical examination”, for example. Each item ID may have the data corresponding to the data number “1” and the data corresponding to the data number “2”. The data number “1” may be a measured value of each item ID, and the data number “2” may be a date on which measured value of each item ID is measured. The display order of the data may be the data numbers “1” and “2” of the height, the data numbers “1” and “2” of the weight, and the data numbers “1” and “2” of the chest measurement in FIG. 5. The display order in this example indicates the display position in the region determined by the style sheet information 352 to be described layer.

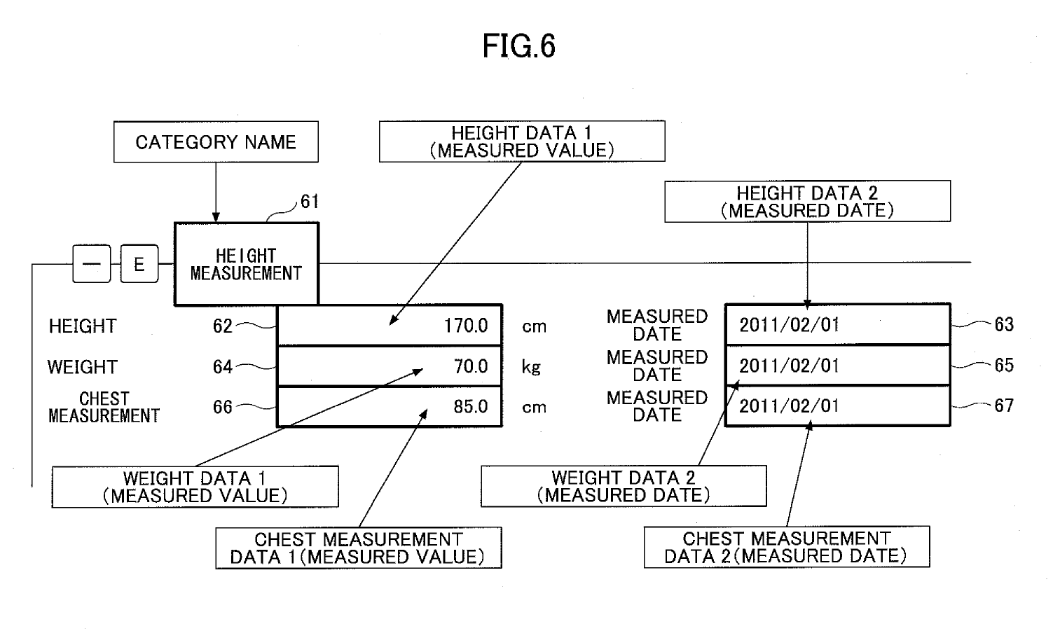

Next, a description will be given of the style sheet information 352, by referring to FIG. 6. FIG. 6 is a diagram for explaining an example of the style sheet.

The storing module 350 of the display control apparatus 300 may prestore the style sheet information 352 that determines the layout with which the medical record information is to be displayed. The style sheet information 352 may display the medical record information with the layout (or format) illustrated in FIG. 6.

The style sheet information 352 (or style sheet) may determine in advance the layout of the display screen of the display unit 33, and determine the display position of the data of each item ID by referring to the display setting information 351.

In this example illustrated in FIG. 6, the category name of the display setting information 351 may be displayed in a region 61, the data of the item ID “height” having the data number “1” may be displayed in a region 62, and the data of the item ID “height” having the data number “2” may be displayed in a region 63. The data of the item ID “weight” having the data number “1” may be displayed in a region 64, and the data of the item ID “weight” having the data number “2” may be displayed in a region 65. Moreover, the data of the item ID “chest measurement” having the data number “1” may be displayed in a region 66, and the data of the item ID “chest measurement” having the data number “2” may be displayed in a region 67.

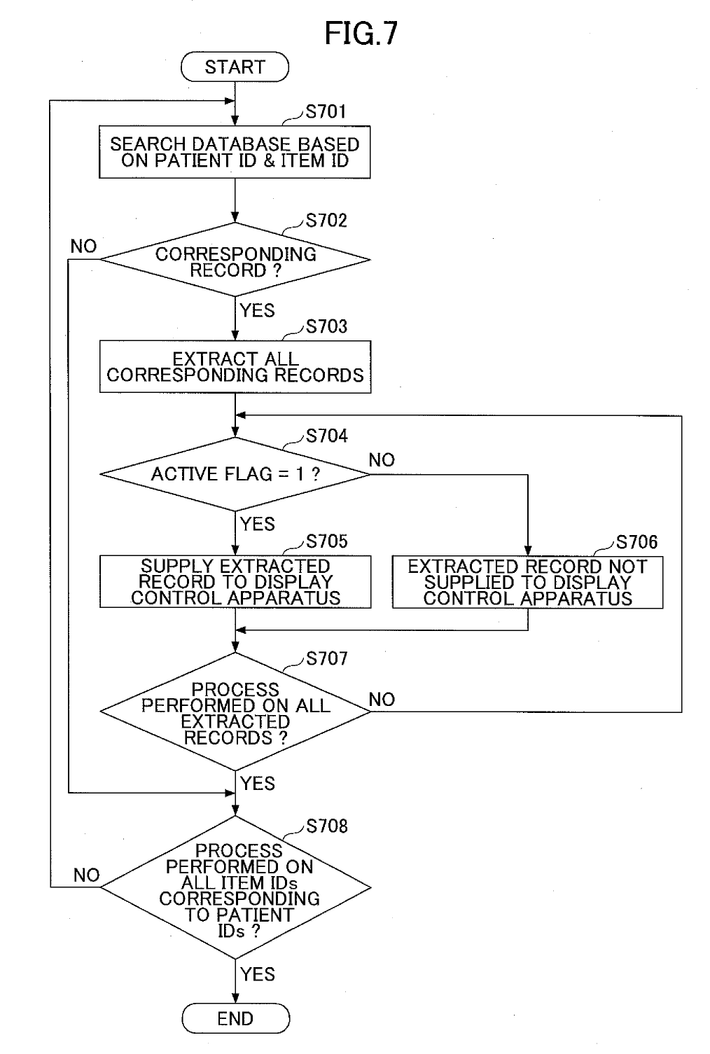

Next, a description will be given of a search process of the search process module 220 of the management server 200, by referring to FIG. 7. FIG. 7 is a flow chart for explaining an example of the search process of the medical record information management server. The search process illustrated in FIG. 7 may be executed by the management server 200 when the search request module 321 of the display control apparatus 300 issues a search request with respect to the medical record information database 210.

When the management server 200 receives the search request with respect to the medical record information database 210 from the display control apparatus 300, the search process module 220 starts the search (step S701). The search request received from the display control apparatus 300 includes the patient ID, and the search process module 220 searches the medical record information database 210 based on a set of this patient ID and the item ID.

Next, the search process module 220 decides whether a corresponding record, that corresponds to the set, exists in the medical record information database 210 (step S702). When the decision result in the step S702 is YES, the search process module 220 extracts all corresponding records (step S703). The extracted records may be temporarily stored in the memory unit and the like of the management server 200.

When the decision result in the step S702 is NO, the process advances to a step S708 to be described later.

After the step S703, the search process module 220 decides whether the active flag of the extracted record is “1” (step S704). When the decision result in the step S704 is YES, the search process module 220 supplies the extracted record to the display control apparatus 300, as the search result (step S704). On the other hand, when the active flag of the extracted record is “0” and the decision result in the step S704 is NO, the search process module 200 does not supply the extracted record to the display control apparatus 300 (step S706).

Next, the search process module 220 decides whether the decision process of the step S704 is performed with respect to all of the records extracted by the step S703 (step S707). When the decision result in the step S707 is YES, the search process module 220 decides whether the process of the steps S701 through S707 is performed with respect to all of the items ID corresponding to the patient ID (step S708).

The process illustrated in FIG. 7 ends when the decision result in the step S708 is YES. On the other hand, when the decision result in the step S708 is NO, the process returns to the step S701 in order to repeat the process of the steps S701 through S707.

Next, the process illustrated in FIG. 7 will be described in more detail. For example, when the management server 200 receives a search request including the patient ID “001”, the search process module 220 extracts all records of the patient ID “001” with the item ID “height”, further extracts the records having the active flag “1”, and supplies the extracted records to the display control apparatus 300. Next, the search process module 220 extracts all records of the patient ID “001” with the item ID “weight”, further extracts the records having the active flag “1”, and supplies the extracted records to the display control apparatus 300

In this embodiment, the management server 200 may supply to the display control apparatus 300 only the record having the active flag “1” for each of item ID. For this reason, the display control apparatus 300 may acquire only the newest data corresponding to the item ID. The active flag may be regarded to be “0” when no data corresponding to the item ID exists.

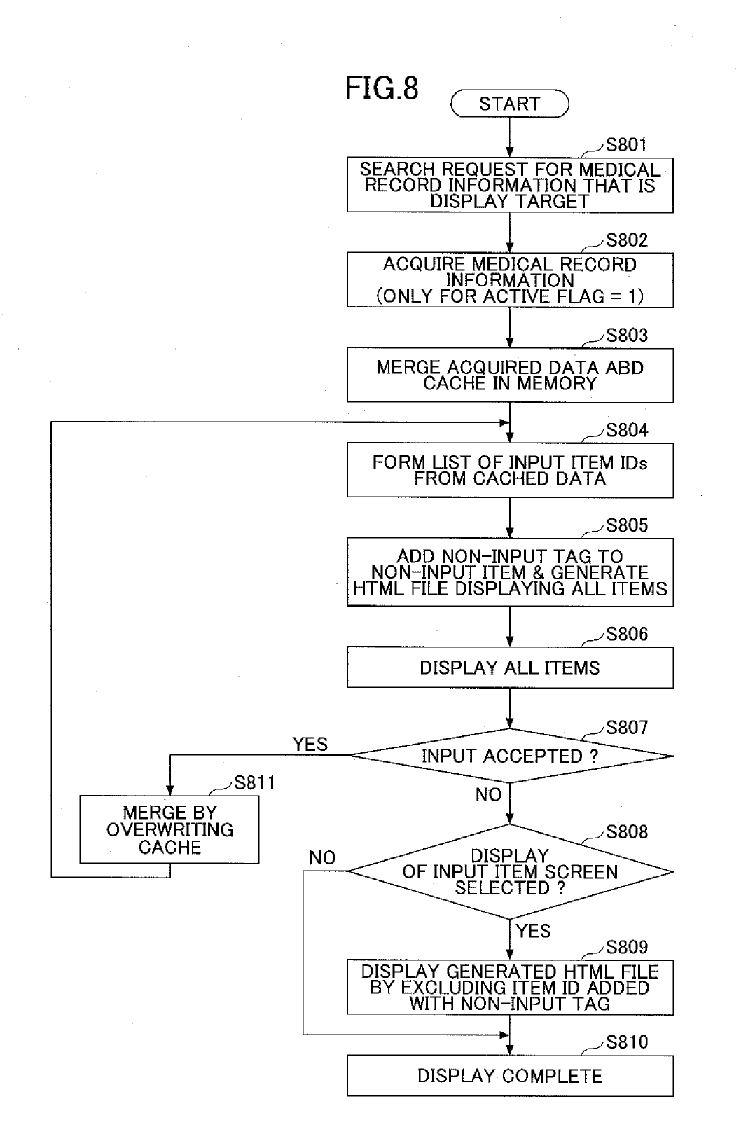

Next, a description will be given of the operation of the display control apparatus 300, by referring to FIG. 8.

The display control apparatus 300 may switch between a screen (hereinafter also referred to as “all-item display screen”) that displays all item IDs set in the display setting information 351 regardless of whether there is the data input, and a screen (hereinafter also referred to as “input item display screen”) that displays only the item IDs for which the data input is made, in response to a switch instruction input by the user. In addition, even when data is newly input to the all-item display screen displayed on the display unit 33 and the medical record information is updated, the display control apparatus 300 may switch the display to the input screen including the newly input data without communicating with the management server 200.

FIG. 8 is a flow chart for explaining an example of a process of the client.

When a display instruction instructing display of the medical record information is made on the display control apparatus 300, the search request module 321 of the display file generating module 320 may issue a search request to the medical record information database 210 (step S801). For example, the search request may be made by the user, such as the medical personnel, who uses the display control apparatus 300. In addition, when the user makes the search request, the input of the patient ID may be requested to the user. When the patient ID is input, the search request module 321 may send this patient ID to the management server 200, as the search request.

Next, the display file generating module 320 may acquire, by the medical record information acquiring module 322, the record of the medical record information supplied from the management server 200 (step S802). The record supplied from the management server 200 is described above in conjunction with FIG. 7.

Thereafter, the display file generating module 320 merges the data included in the acquired record and caches the merged data in a memory, by the medical record information acquiring module 322 (step S803). The memory in which the data is temporarily stored may be formed by the memory unit 32 or the storage unit 35, for example.

Then, the display file generating module 320 forms a list of the item IDs to which the data 1 and the data 2 are input, by the data list forming module 323, based on the cached data (step S804). Next, the display file generating module 320 adds a “non-input tag” to the item ID to which no data input is made, and generates the HTML file to be displayed using the style sheet information 352, by the screen file generating module 324 (step S805). The screen file generating module 324 may generate the HTML file to display all item IDs set in the display setting information 351.

Next, a more detailed description will be given of the process of the steps 5804 and 5805. An example of a case will be described, in which the data 1 and the data 2 corresponding to the item ID “height” and the item ID “weight” are cached in the step S803, and the data 1 and the data 2 corresponding to the item ID “chest measurement” are not acquired. In this case, the data list forming module 323 may form a list of the item ID “height” and the item ID “weight” that are input with the data 1 and the data 2.

The screen file generating module 324 may compare the list that is formed and the display setting information 351, and judge that amongst the item IDs included in the display setting information 351, the item ID that is not in the list is a non-input item ID to which no data input is made. In addition, the item ID that is in the list and also exists in the display setting information 351 may be regarded as an input item ID to which the data input is made.

The screen file generating module 324 may add the “non-input tag” to the data corresponding to the non-input item ID of the style sheet information 352, and add the corresponding cached data 1 and the data 2 to the data corresponding to the input item ID of the style sheet information 352, in order to generate the HTML file. The screen file generating module 324 may supply the HTML file that is generated to the display control module 310.

The display control module 310 may acquire the HTML file, and display on the display unit 33, based on the HTML file, the screen including all of the items included in the display setting information 351 (step S806). The all-item display screen including the non-input item ID may be displayed by the step S806.

Next, the input accepting module 330 of the display control apparatus 300 may decide whether the newly input data is accepted in a state in which the all-item display screen is displayed (step S807). When the decision result in the step S807 is NO, the display control module 310 may decide whether the display of the input item display screen is selected on the all-item display screen that is displayed (step S808).

When the display of the input item display screen is selected in the step S808, the display control module 310 may display the HTML file received from the screen file generating module 324 on the display unit 33 so that the item ID added with the “non-input tag” is not displayed (step S809), and complete the display (step S810).

When the display of the input item display screen is not selected in the step S808, the display control module 310 may complete the display (step S810).

When the input accepting module 330 accepts the newly input data in the step S807, the medical record information acquiring module 322 may cache the newly input data in the memory, and merge the newly input data with the data cached in the step S803 by writing the newly input data over the data cached in the step S803, for example (step S811). Then, the display file generating module 320 may return the process to the step S804.

Accordingly, the display control apparatus 300 may switch between the all-item display screen that displays all item IDs of the medical record information including the non-input item ID to which no data input is made, and the input item display screen that displays only the input item IDs for which the data input is made and the data corresponding to the input item IDs, in response to the switch instruction. In addition, even when data is newly input to the all-item display screen, the display control apparatus 300 by itself may update the display screen without communicating with the management server 200. Furthermore, the display control apparatus 300 by itself may display the input item display screen which reflects the update.

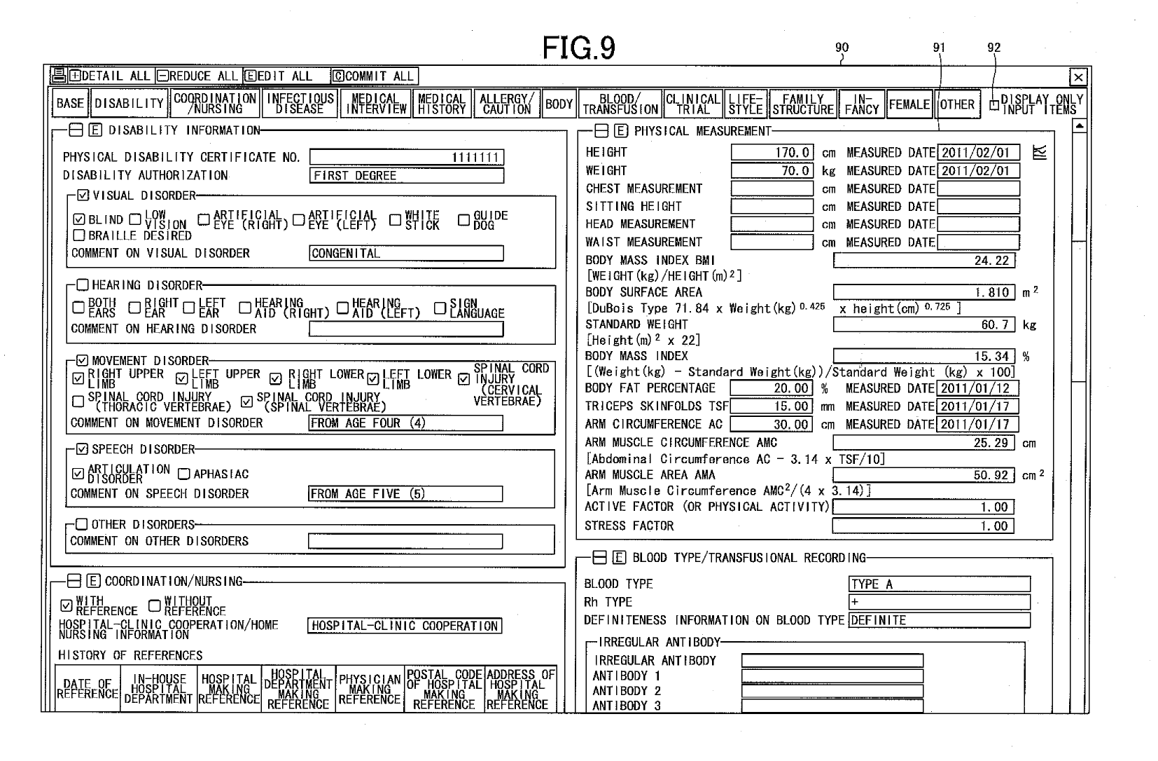

Next, a description will be given of the switching of the display screen by the display control module 310 of the display control apparatus 300, by referring to FIGS. 9 through 11.

FIG. 9 is a diagram illustrating an example of the all-item display screen. In an all-item display screen 90 illustrated in FIG. 9, the display region is segmented for each of the plurality of categories, and the item ID included in the category is displayed within each display region.

For example, the display region 91 displays the category “physical examination”, and al of the item IDs included in the category name “physical examination” of the display setting information, such as the item IDs “height”, “weight”, and “chest measurement”, are displayed within the display region 91. In the display region 91, the data 1 that is a measured value and the data 2 that is a measured data are input only to the item ID “height” and the item ID “weight”.

In addition, the all-item display screen 90 displays a check box 92 in order to enable a selection between the display of the all-item display screen and the input item display screen by the switch instruction. In this example, the display control module 310 may judge that the input item display screen is selected by the switch instruction when a check is input to the check box 92.

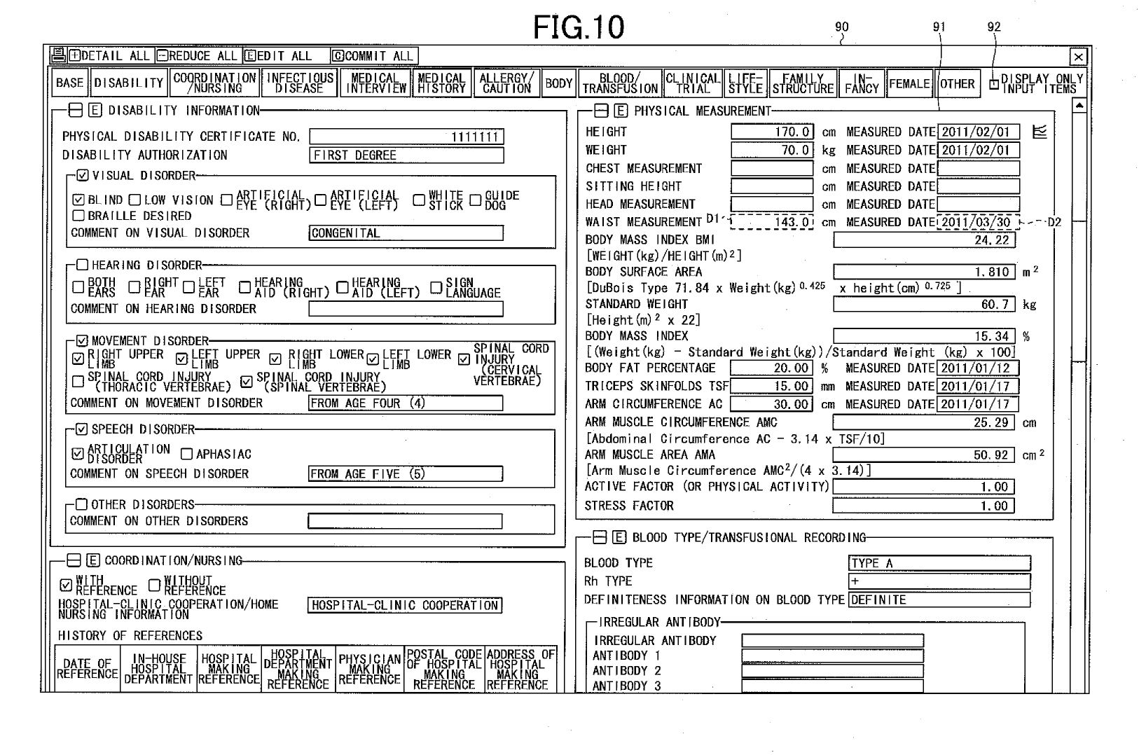

FIG. 10 is a diagram illustrating an example of a case in which a data input is accepted on the all-item display screen. In the all-item display screen 90 illustrated in FIG. 10, data D1 and D2 corresponding to the item ID “chest measurement” are input in the display region 91 of the category “physical examination”. The data D1 is a measured value, and the data D2 is a measured date.

In this example, when the data corresponding to the non-input item ID, to which no new data input is made, is input as illustrated in FIG. 10, the input data may be stored in the memory unit 32 or the like of the display control apparatus 300, and written over the data acquired by the display control apparatus 300 from the management server 200.

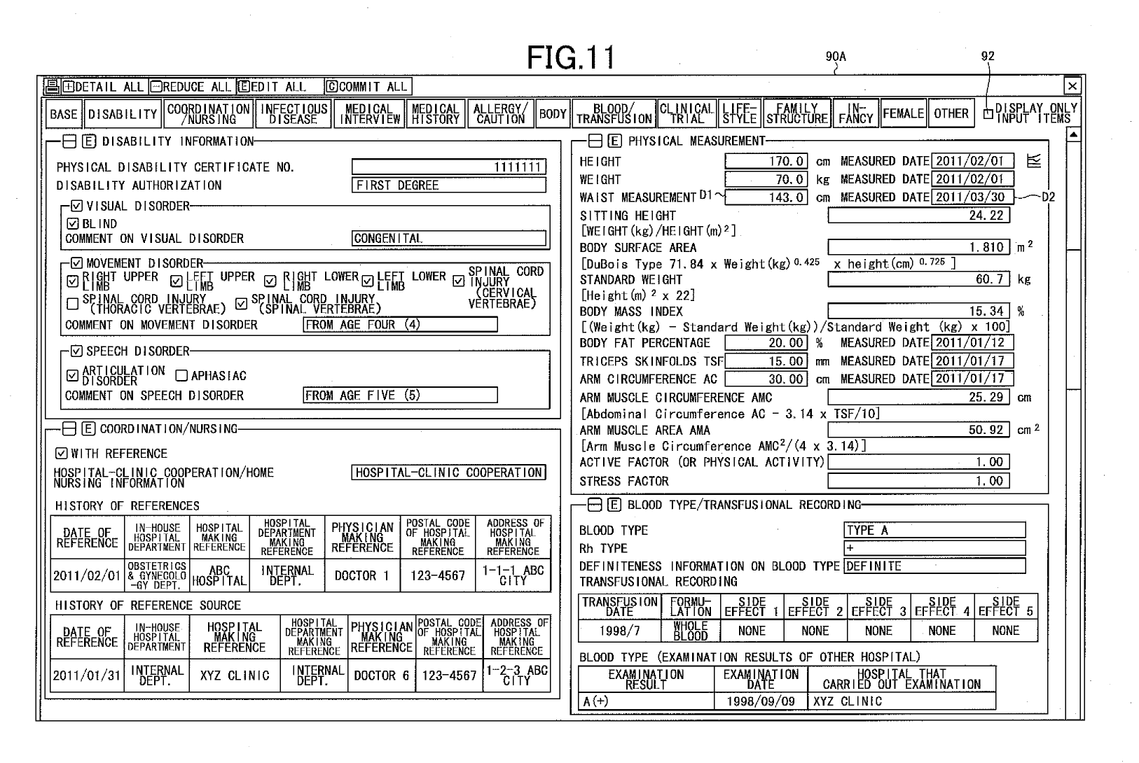

FIG. 11 is a diagram illustrating an example of the input item display screen already input with the data. A check is input to a check box 92 on an input item display screen 90A illustrated in FIG. 11 by the switch instruction, and only the input item IDs to which the data input is made are displayed.

The input item display screen 90A may also display the item ID “chest measurement” that is input with the data D1 and D2 on the all-item display screen 90. In this example, because the data D1 and D2 input on the all-item display screen 90 are stored in the display control apparatus 300, the display control apparatus 300 may by itself display the input item display screen 90A after the data D1 and D2 are newly input.

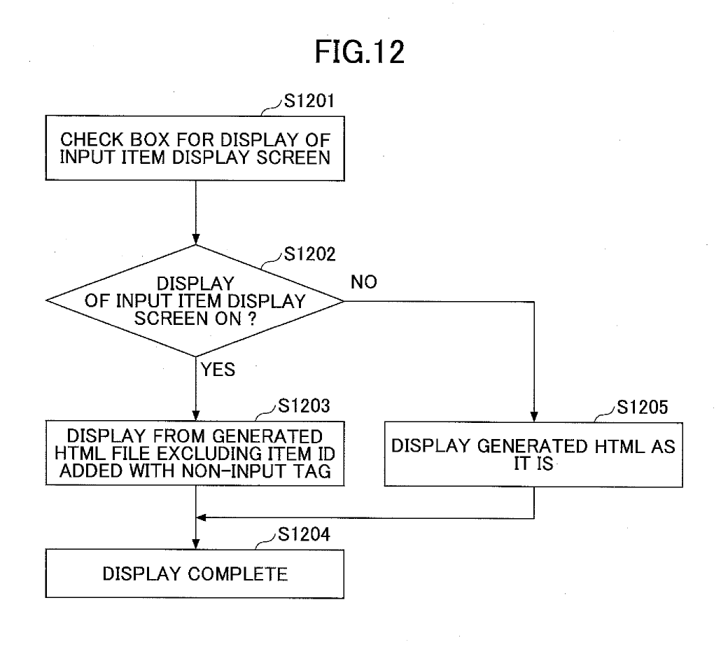

Next, a description will be given of a display switching for a case in which the check is input to the check box 92 to instruct the display switching, by referring to FIG. 12. In this example, the display control module 310 may perform the display switching using the HTML file generated by the display file generating module 320. In other words, the all-item display screen and the input item display screen may be displayed using the same HTML file. FIG. 12 is a flow chart for explaining an example of the display switching by a display control module.

In FIG. 12, when a check is input to the check box 92 on the all-item display screen 90 (step S1201) by the switch instruction, the display control module 310 decides whether the display of the input item display screen is ON (step S1202). The display of the input item display screen is selected when the input item display screen is ON. Hence, when the decision result in the step S1202 is YES, the display control module 310 displays on the display unit 33 the input item display screen, excluding the item IDs added with the “non-input tag”, from the HTML file generated by the display file generating module 320 (step S1203), and completes the display (step S1204).

The display of the all-item display screen is selected when the input item display screen is OFF (or not ON). Hence, when the decision result in the step S1202 is NO, the display control module 310 renders the HTML file generated by the display file generating module 320, as it is, and displays the all-item display screen on the display unit 33 (step S1205), and completes the display (step S1204).

Accordingly, the display control module 310 may switch the display between the all-item display screen and the input item display screen, using the HTML file generated by the display file generating module 320. For this reason, when only the input item IDs to which the data input is made are to be viewed, for example, the display may be switched to the input item display screen in order to collectively display the medical record information that is input and improve the viewing ease or visibility.

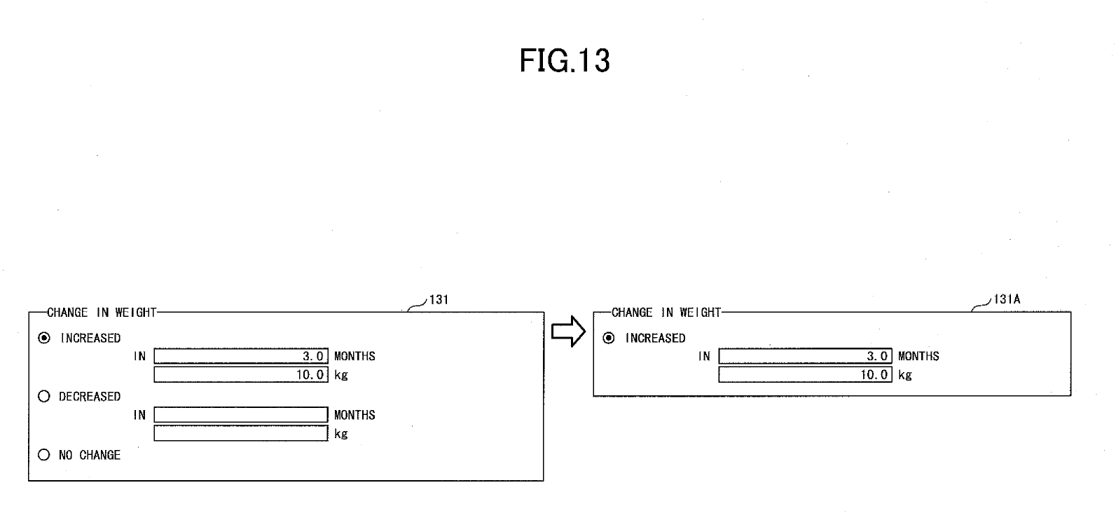

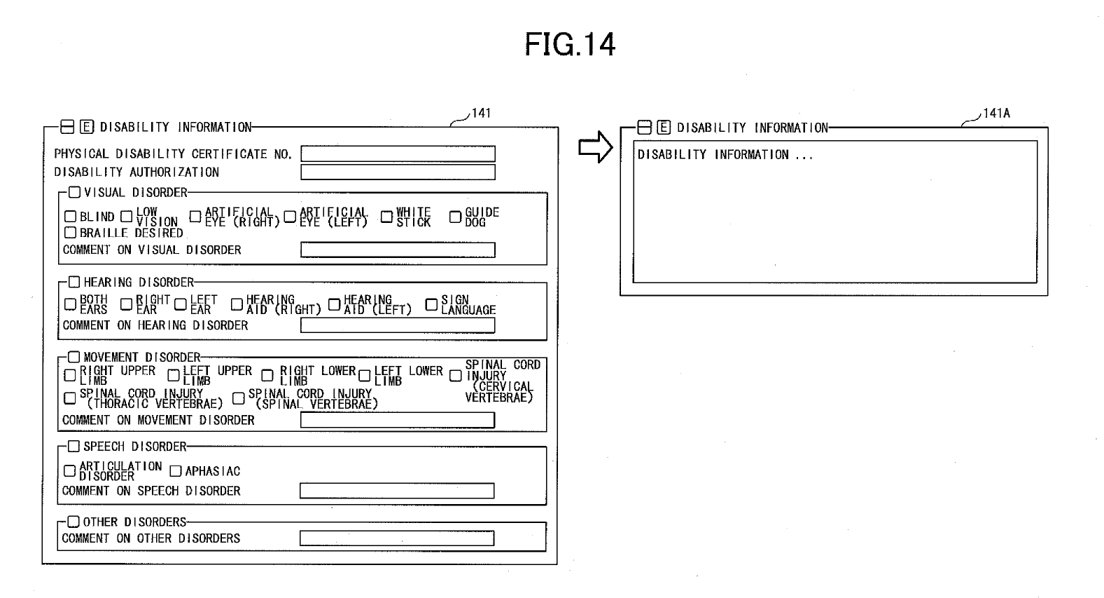

Next, a description will be given of the display switching between the all-item display screen and the input item display screen, by referring to FIGS. 13 and 14.

FIG. 13 is a diagram illustrating a first example of the display switching between the all- item display screen and the input item display screen.

A display region 131 illustrated on the left side of FIG. 13 displays a category “change in weight” on the all-item display screen. The display region 131 employs a format in which the item ID is selected and the data is input to the selected item ID. When the display switches the input item display screen, the display within the display region 131 changes to the display within a display region 131A illustrated on the right side of FIG. 13. In the display region 131A, the item IDs not selected in the display region 131 are not displayed, that is, are non-displayed item IDs.

In the example illustrated in FIG. 13, unwanted options that are not selected are not displayed, in order to display only the information preferred by the user.

FIG. 14 is a diagram illustrating a second example of the display switching between the all-item display screen and the input item display screen.

A display region 141 illustrated on the left side of FIG. 14 displays a category “disability information” on the all-item display screen. In the example illustrated in FIG. 14, all of the item IDs in the display region 141 are non-input item IDs to which no data input is made.

When the display is switched to the input item display screen, the display within the display region 141 changes to the display within a display region 141A illustrated on the right side of FIG. 14. In the display region 141A, no input item ID exists, and thus, a summary of the disability information and the like are displayed. The display file generating module 320 may include in the HTML file the summary and the like describing each category in advance.

Therefore, according to this embodiment, an appropriate display switching may be performed in the display region for each category.

The user of the display control apparatus 300 of this embodiment may be medical personnel, such as physicians, nurses, and medical technologists. For example, when the user of the display control apparatus 300 is a physician, the physician may mainly view the medical record information on the display control apparatus 300. In addition, when the user of the display control apparatus 300 is a nurse or a medical technologist, the nurse or medical technologist may mainly input information to the medical record information on the display control apparatus 300.

Hence, in this embodiment, the screen on which the medical record information is first displayed when the display control apparatus 300 is started may be selectable and set to the all-item display screen or the input item display screen, based on user information that is input when the user makes a log-in to the electronic medical record system 100, for example. For example, when the user information indicates that the user is a physician, the display control apparatus 300 may initially display the input item display screen. On the other hand, when the user information indicates that the user is a nurse, for example, the display control apparatus 300 may initially display the all-item display screen.

In addition, when the display control apparatus 300 receives the store instruction to store the medical record information from the user in this embodiment, the store process module 340 may send the medical record information to the management server 200. Hence, the management server 200 may store the medical record information received from the display control apparatus 300 in the medical record information database 210 by the update process module 230, in order to update the medical record information database 210.

Therefore, according to this embodiment, the medical record information may be sent to the management server 200 only when the store instruction to store the medical recording information is issued under the clear intent of the user. Thus, the medical record information may be prevented from being sent to the management server 200 unless the store instruction to store the medical record information is issued by the user. Consequently, the medical record information may be prevented from being stored in the management server 200 at an inappropriate timing, such as when an input operation is being made to input the data, when a confirmation operation is being made to confirm the input contents, and the like, for example.

Further, in this embodiment, the display control apparatus 300 may, by itself, reflect the newly input data to the all-item display screen and the input item display screen, without having to communicate with the management server 200. Hence, after the data is newly input on the all-item display screen, for example, the contents of the newly input data may be confirmed on the input item display screen by switching the display from the all-item display screen to the input item display screen.

### Second Embodiment

Next, a description will be given of a second embodiment of the present invention. The second embodiment may differ from the first embodiment in that the display file generating module is provided in the management server.

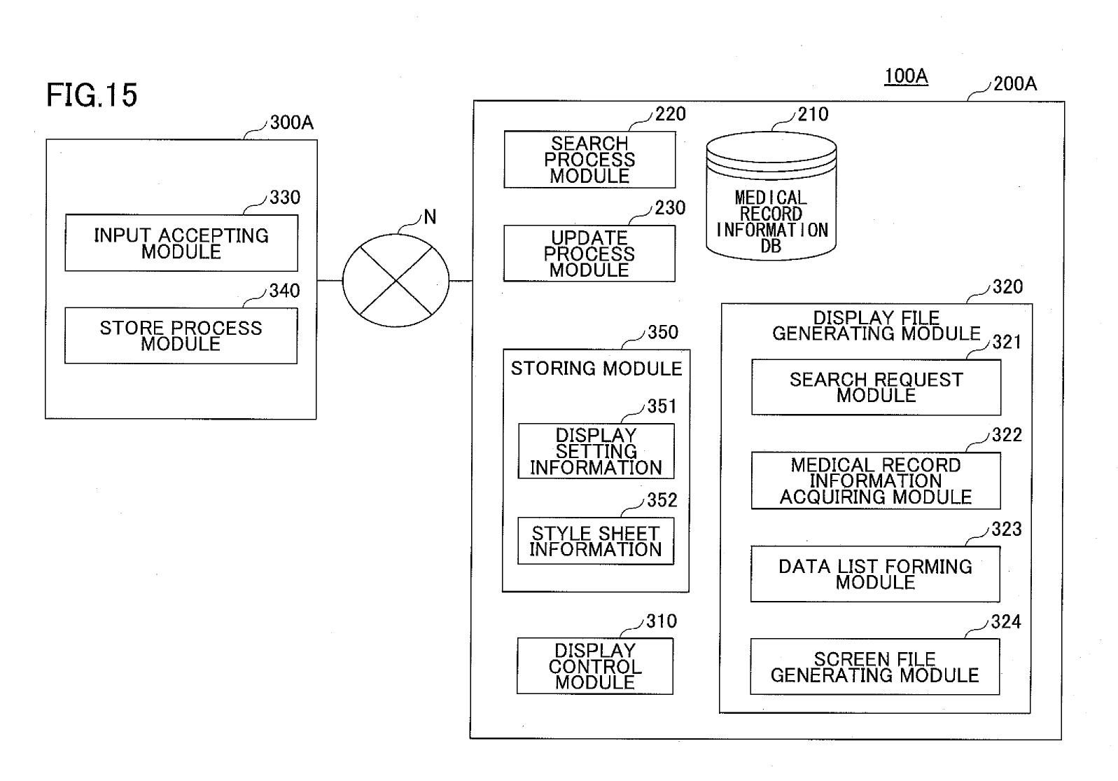

FIG. 15 is a diagram illustrating an example of the system structure of the electronic medical record system in the second embodiment. In FIG. 15, those parts that are the same as those corresponding parts in FIG. 3 are designated by the same reference numerals, and a description thereof will be omitted.

An electronic medical record system 100A illustrated in FIG. 15 may include a management server 200A and a display control apparatus 300A. The management server 200A and the display control apparatus 300A may be connected via a network N.

The management server 200A may include, in addition to the constituent elements of the management server 200 of the first embodiment, a display control module 310, a display file generating module 320, and a storing module 350. When the management server 200A receives from the display control apparatus 300A a display instruction to display the medical record information, the display file generating module 320 may generate a HTML file and supply the generated HTML file to the display control module 310.

When the display control apparatus 300A makes an access to the management server 200A, display control module 310 of the management server 200A may display an all-item display screen on the display unit of the display control apparatus 300A.

The HTML file may be generated by the display file generating module 320 in the same manner as the first embodiment.

When the input accepting module 330 of the display control apparatus 300A accepts the newly input data, the newly input data may be sent to the management server 200A. In the management server 200A, the display file generating module 320 may newly generate a HTML file, and supply the newly generated file to the display control module 310. The display control apparatus 300A may make an access to the HTML file, and display an all-item display screen which reflects the newly input data.

When a store instruction to store the medical record information is sent from the store process module 340 of the display control apparatus 300A to the management server 200A, the update process module 230 may update the medical record information database 210.

Therefore, this second embodiment may obtain effects similar to those obtainable by the first embodiment described above.

Although the embodiments are numbered with, for example, “first,” or “second,” the ordinal numbers do not imply priorities of the embodiments. Many other variations and modifications will be apparent to those skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A medical record information display control method comprising:
receiving from a server by a computer, data input to at least one of a plurality of display setting items that are preset amongst a plurality of items included in medical record information;
displaying on a display unit by the computer, an all-item display screen that displays the plurality of display setting items and the received data;
setting by the computer, input data on the all- item display screen when the input data with respect to another item other than the at least one of the plurality of display setting items is accepted;
switching by the computer, the all-item display screen to an input item display screen in response to a switch instruction; and
storing in the server by the computer, data including the input data in response to a store instruction,
wherein the input item display screen displays the at least one of the plurality of display setting items, the received data, and the other item.

2. The medical record information display control method as claimed in claim 1, further comprising:
generating, by the computer, a display file to display a screen on the display unit, based on the plurality of display setting items, data corresponding to the plurality of display setting items, and information indicating a prestored layout; and
displaying on the display unit by the computer, one of the all-item display screen and the input item display screen using the display file.

3. The medical record information display method as claimed in claim 2, wherein the all-item display screen and the input item display screen are displayed on the display unit using the same display file.

4. The medical record information display method as claimed in claim 2, further comprising:
forming, by the computer, a list of the data received from the server, and items corresponding to the received data amongst the plurality of display setting items; and
generating, by the computer, the display file by comparing the items in the list and predetermined items of the plurality of display setting items, and regarding the predetermined items not included in the list as non-input items to which no data input is made.

5. The medical record information display method as claimed in claim 1, wherein
the receiving, the displaying, the setting, the switching, and the storing are executed by a computer of a display control apparatus that is coupled to the server via a network, and
the display unit is coupled to the display control apparatus.

6. The medical record information display method as claimed in claim 1, wherein
the receiving and the storing are executed by a computer of a display control apparatus that is coupled to the server via a network,
the displaying, the setting, and the switching are executed by a computer of the server, and
the display unit is coupled to the display control apparatus.

7. A medical record information display control apparatus comprising:
a processor configured to perform a process to control display of medical record information,
the processor including
a display control module configured to receive, from a server, data input to at least one of a plurality of display setting items that are preset amongst a plurality of items included in the medical record information, and display on a display unit an all-item display screen that displays the plurality of display setting items and the received data;
an input accepting module configured to set input data on the all-item display screen when the input data with respect to another item other than the at least one of the plurality of display setting items is accepted; and
a store process module configured to send data including the input data to the server to be stored in the server in response to a store instruction,
wherein the display control module switches the all-item display screen to an input item display screen in response to a switch instruction, and
wherein the input item display screen displays the at least one of the plurality of display setting items, the received data, and the other item.

8. The medical record information display control apparatus as claimed in claim 7, wherein the processor further includes
a display file generating module configured to generate a display file to display a screen on the display unit, based on the plurality of display setting items, data corresponding to the plurality of display setting items, and information indicating a prestored layout,
wherein the display control module displays on the display unit one of the all-item display screen and the input item display screen using the display file.

9. The medical record information display apparatus as claimed in claim 8, wherein the display control module displays the all-item display screen and the input item display screen on the display unit using the same display file.

10. The medical record information display apparatus as claimed in claim 8, wherein the processor further includes
a data list forming module configured to form a list of the data received from the server, and items corresponding to the received data amongst the plurality of display setting items; and
a display file generating module configured to generate the display file by comparing the items in the list and predetermined items of the plurality of display setting items, and regarding the predetermined items not included in the list as non- input items to which no data input is made.

11. A non-transitory computer-readable storage medium having stored therein a program for causing a computer to execute a process comprising:
receiving, from a server, data input to at least one of a plurality of display setting items that are preset amongst a plurality of items included in medical record information;
displaying, on a display unit, an all-item display screen that displays the plurality of display setting items and the received data;
setting input data on the all-item display screen when the input data with respect to another item other than the at least one of the plurality of display setting items is accepted;
switching the all-item display screen to an input item display screen in response to a switch instruction; and
storing, in the server, data including the input data in response to a store instruction,
wherein the input item display screen displays the at least one of the plurality of display setting items, the received data, and the other item.

12. The non-transitory computer-readable storage medium as claimed in claim 11, wherein the process further comprises:
generating a display file to display a screen on the display unit, based on the plurality of display setting items, data corresponding to the plurality of display setting items, and information indicating a prestored layout; and
displaying, on the display unit, one of the all-item display screen and the input item display screen using the display file.

13. The non-transitory computer-readable storage medium as claimed in claim 12, wherein the all-item display screen and the input item display screen are displayed on the display unit using the same display file.

14. The non-transitory computer-readable storage medium as claimed in claim 12, wherein the process further comprises:
forming a list of the data received from the server, and items corresponding to the received data amongst the plurality of display setting items; and
generating the display file by comparing the items in the list and predetermined items of the plurality of display setting items, and regarding the predetermined items not included in the list as non-input items to which no data input is made.

15. The non-transitory computer-readable storage medium as claimed in claim 11, wherein
the receiving, the displaying, the setting, the switching, and the storing are executed by a computer of a display control apparatus that is coupled to the server via a network, and
the display unit is coupled to the display control apparatus.

16. The non-transitory computer-readable storage medium as claimed in claim 11, wherein
the receiving and the storing are executed by a computer of a display control apparatus that is coupled to the server via a network,
the displaying, the setting, and the switching are executed by a computer of the server, and
the display unit is coupled to the display control apparatus.
